(19) United States
(12) Patent Application Publication
(10) Pub. No.: US 2003/0138046 A1
(43) Pub. Date: Jul. 24, 2003

(54) Method for coding and decoding video signals

(75) Inventors: Gero Base, Munchen (DE); Norbert Oertel, Muenchen (DE); Juergen Pandel, Wohnsitz (DE)

Correspondence Address: STAAS & HALSEY LLP, 700 11TH STREET, NW, SUITE 500, WASHINGTON, DC, 20001, US

(73) Assignee: Siemens AG, Munich (DE)

(21) Appl. No.: 10/243,953

(22) Filed: Sep. 16, 2002

(30) Foreign Application Priority Data
Sep. 14, 2001 (DE) 101 453 72.8
Jun. 5, 2002 (DE) 102 249 96.2

(51) Int. Cl. H04N 7/12

(52) U.S. Cl. 375/240.12

(57) ABSTRACT

Spectral coefficients of a transformed prediction error matrix are linearized and converted to a sequence of levels and lengths by scanning. The level coefficients are arranged by sorting on the basis of their magnitude. The level sequence resulting from this, as well as sorting information, are subjected to differential coding.

### CROSS REFERENCE TO RELATED APPLICATIONS

This application is based on and hereby claims priority to German Application No. 101 45 372.8 filed on Sep. 14, 2001 and German Application No. 102 249 96.2 filed on Jun. 5, 2002, the contents of which are hereby incorporated by reference.

### BACKGROUND OF THE INVENTION

1. Field of the Invention

The invention relates to coding and decoding video signals.

2. Description of the Related Art

Effective coding of video signals is required especially for transporting video data via packet-oriented data networks, since the bandwidth of packet-oriented data networks is tightly constrained. Standardized methods, such as MPEG-1, MPEG-2 and H.26L, have therefore been developed, by which video signals can be effectively coded and compressed. The standardized methods operate using motion-compensating hybrid coding, a combination of redundancy reduction without losses and lossy irrelevance reduction.

So-called motion-compensating prediction is generally used for compression. Motion-compensating prediction makes use of the similarity between successive frames by using frames which have already been transmitted to predict the frame to be coded at any given time. Since, in general, only specific parts move in successive frames, an encoder breaks down the picture to be coded at any given time into rectangular macro blocks. The coder searches for matching macro blocks, for each of these macro blocks, from the already transmitted frames, and calculates their displacement with respect to the macro blocks for the frame to be coded at that time. The displacements between the macro blocks are described by motion vectors, which are coded by the coder using code tables.

Since the frame to be coded at any given time cannot always be constructed by displacement of macro blocks of already transmitted frames, for example when new objects come into the picture, the prediction error must also be transmitted from the coder to the decoder. This prediction error is obtained from the difference between the frame which is actually to be coded at that time and the prediction picture constructed by displacement of the macro blocks from preceding frames.

Since the prediction errors between adjacent pixels correlate with areas which cannot be predicted, or can be predicted only poorly, the prediction errors are transformed from the position domain to the frequency domain, for further redundancy reduction. Different transformation methods are used in this case, depending on the compression method. By way of example, discrete wavelet transformation (DWT) or discrete cosine transformation (DCT), as well as integer transformation, are normally used. The transformation process is used, for example, to transform the prediction error data associated with a macro block formed of 8×8 pixels to a transformed prediction error matrix having a 8×8 spectral coefficients. In this case, the first spectral coefficient represents the mean brightness, for which reason this is also referred to as the “constant component”. As the index number rises, the remaining spectral coefficients reflect higher-frequency components of the prediction error data, and are thus also referred to as “changing components”.

To reduce the required data rate further, the spectral coefficients are quantized before further coding. If the prediction error data changes only slowly from one pixel to the next, most high-frequency spectral coefficients are equal to zero after quantization. Thus, as a rule, a thinly occupied, transformed and quantized prediction error matrix is produced after quantization, in which only the spectral coefficients in the vicinity of the constant component are not equal to zero. The transformed and quantized prediction error matrix is then linearized by a process of scanning the spectral coefficients. The sequence of spectral coefficients resulting from the scanning process is represented as a sequence of tuples, which each contain a length and a level. The level in this case indicates the value of a spectral coefficient which is not equal to zero while, in contrast, the length indicates the number of zeros which are located between the level and the preceding spectral coefficient not equal to zero. The sequence of levels and lengths is, finally, supplied to entropy coding.

### SUMMARY OF THE INVENTION

Against the background of this prior art, the invention is based on the object of further improving the known methods for video coding and video decoding.

According to the invention, this object is achieved by providing a prediction error matrix; converting the prediction error matrix to a sequence of level coefficients and length coefficients of zero sequences; sorting the level coefficients on the basis of their magnitude and forming a sequence of sorting coefficients; and differential coding of the level coefficients.

This object is further achieved by differential decoding of the level coefficients; decoding sorting information and re-sorting of the level coefficients on the basis of the sorting information; and conversion of the sequence of level coefficients and length coefficients of zero sequences to a prediction error matrix.

The sorting of the levels on the basis of their magnitude results in a level sequence in which successive levels differ only slightly. The sorted level sequence can thus be particularly effectively differentially coded by forming differences between levels and by then subjecting the difference magnitudes to entropy coding.

In one preferred embodiment, the difference magnitudes are described by tuples, in which a first number indicates the difference from an adjacent level, and a second number indicates how often the level occurs.

Since the same levels frequently occur successively in the sorted level sequence, the information contained in the levels can be combined in an effective manner by the described tuples. A further advantage of this representation is that no separate symbol is required to indicate the end of the level sequence.

In a further preferred embodiment, the sorting information is also differentially coded. The sorting information is in this case preferably coded using a predictor, by in each case calculating the differences with respect to the predictor. The value of the predictor is in each case equal to the most recently sorted coefficient, in a rising sequence of sorting coefficients. If a sorting coefficient is intended to be coded which is less than the preceding sorting coefficient, the predictor is once again reset to zero.

This procedure allows the sorting information to be coded particularly effectively, since the large values of the sorting coefficients are converted to a sequence of frequently identical difference values which have small magnitudes and are intrinsically particularly suitable for efficient coding.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 is a block diagram of an encoder which operates on the principle of motion-compensating hybrid coding; and

FIG. 2 is a block diagram of steps in the coding method illustrated in FIG. 1.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

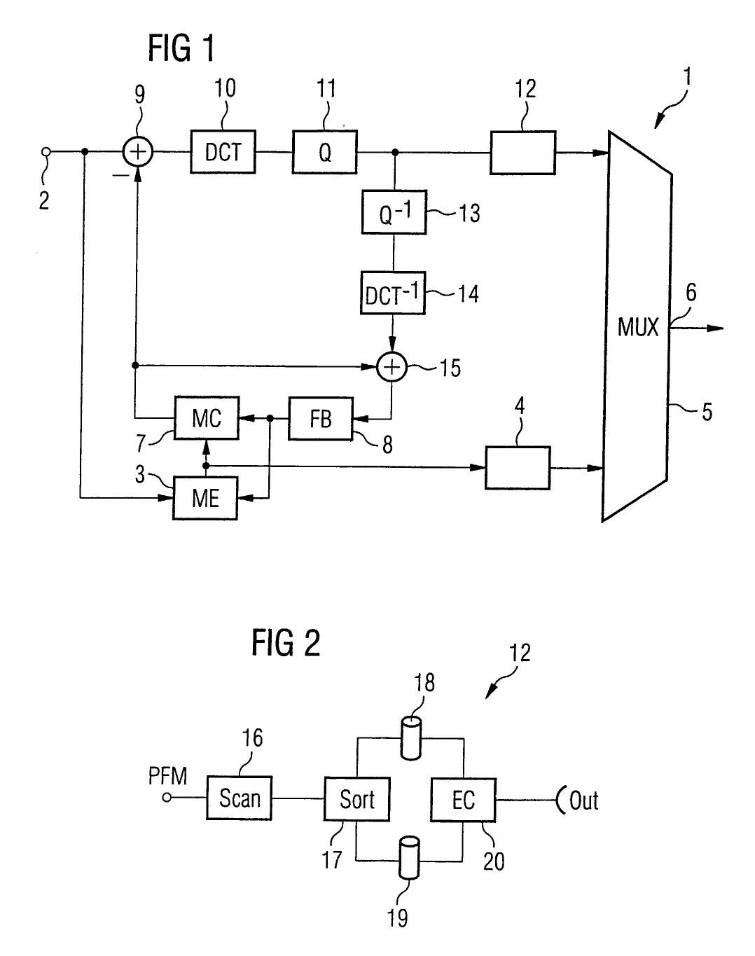

The block diagram of a coding method as illustrated in FIG. 1 may also be regarded as the block diagram of an apparatus, namely the block diagram of an encoder. For the sake of simplicity, the coding method will be explained in more detail in the following text with reference to the encoder 1 as illustrated in FIG. 1. However, it should be obvious to those skilled in the art that, in principle, this description also relates to a coding method.

FIG. 1 shows an encoder or coder 1 which operates on the principle of motion-compensating hybrid coding. The coder 1 has an input 2 via which the video data stream is supplied to the coder 1. In particular, video data from a frame sequence is supplied via the input 2 to the coder. A motion estimation unit 3 segments one frame to be coded at the time from the video data stream into rectangular macro blocks, which generally have a size of 8×8 or 16×16 pixels. For each of these macro blocks, the motion estimation unit 3 searches the already transmitted frames for matching macro blocks, and calculates their motion vectors. The motion vectors can then be coded using conventional code tables or else using a context-sensitive coding unit 4, and can be embedded, via a multiplexer 5, in a bit stream which is emitted at an output 6. The motion vectors of the macro blocks as calculated by the motion estimation unit 3 are also signaled to a motion compensator 7 which, on the basis of the already transmitted frames that are stored in a frame store 8, calculates the prediction picture which results by the displacement of the macro blocks of the already transmitted frames. This prediction picture is subtracted in a subtractor 9 from the original picture to produce a prediction error, which is supplied to a discrete cosine transformer 10 with a downstream quantizer 11. The prediction error is also referred to as the texture. The transformed and quantized prediction error is passed to a further context-sensitive coding unit 12, which converts the transformed and quantized prediction error data to bit stream segments, which are read by the multiplexer 5 and are embedded in the bit stream which is emitted at the output 6.

The processing in the discrete cosine transformer 10 results in the macro blocks being represented by, for example 8×8 pixels as a matrix of 64 spectral coefficients. In this case, the first coefficient contains the mean brightness and is therefore also referred to as the constant component or DC coefficient. The remaining spectral coefficients reflect higher-frequency components of the brightness distribution as the index number rises, for which reason they are referred to as changing components or AC coefficients. The data rate is reduced further by the downstream quantizer 11. This is because, in the case of flat elements, the prediction error changes only slowly from one pixel to the next so that, after processing in the quantizer 11, the high-frequency spectral coefficients are equal to zero and therefore do not need to be transmitted at all at this stage.

The quantizer 11 can furthermore also take account of psycho-visual effects. This is because the human brain perceives low-frequency picture components, specifically picture components with areas of large extent, considerably more clearly than high-frequency picture components, namely details. The high-frequency spectral coefficients can therefore be quantized more coarsely than the low-frequency spectral coefficients.

To readjust the frames which have already been transmitted and are stored in the frame store 8, the spectral coefficients are supplied to an inverse quantizer 13 and to an inverse discrete cosine transformer 14, and the prediction error data reconstructed in this way is added in an adder 15 to the prediction picture produced by the motion compensator 7. The picture produced in this way corresponds to that picture which is obtained during decoding. This picture is stored in the frame store 8 and is used by the motion estimation unit 3 as the basis for calculation of the motion vectors for the next frame.

The function of the coding unit 12 will be described in more detail with reference to FIG. 2. The coding unit 12 illustrated in FIG. 2 has a scanning unit 16, which linearizes the prediction error matrices PFM supplied from the quantizer 11, and converts them to a sequence of levels and lengths. The scanning unit 16 is followed by a sorter 17, which sorts the levels on the basis of their magnitude. This results in a sorted level sequence 18, which is supplied in the same way as the sorting information 19 to an entropy coder 20.

The sorting method itself will now be described in more detail: The levels supplied from the scanning unit 16 are preferably initially sorted on the basis of their magnitude. In principle, any conventional sorting methods may be used for sorting the levels on the basis of their magnitude. However, one sorting method which has been found to be particularly highly suitable for this purpose is “insertion sorting”, since the sequence of levels has frequently already been sorted, except for intermediate zeros. Elementary sorting methods as well as the “insertion sorting” method are known, for example, from the book by Robert Sedgewick, “Algorithms”, Addison-Wesley, 1991, Chapter 8, pages 121-136.

An index field that is associated with the level sequence is also converted when the levels are sorted. The index field which results from the sorting of the levels in the sorter 17 is, in one advantageous refinement of the sorting method, not coded and transmitted directly, but is first of all converted to the sorting information 19 by a marker field M, which has the same dimension as the index field and is initially not marked at all positions.

The sorting information 19 is in this case formed as follows. If there are a total of k levels other than zero, then, for the first k indices of the unsorted index field in its given sequence in the marker field, the number of unmarked points from the start is counted until the index is reached which is the next to be coded in the sorted index field. The number of unmarked points is stored and is supplied later on to the entropy coder 20, and is sent to the decoder. The position in the marker field is then identified as being marked, and the process continues with the next index.

In the simplest case, when no resorting of the levels takes place, the sorting information consists purely of zeros.

It should be noted that the decoder only needs to know the positions of the levels which are not zero; zeros must necessarily be located at all the other positions. It is thus completely sufficient to consider only the first k positions in the index field, if k levels are not equal to zero.

The procedure for sorting and forming the sorting information 19 will now be described with reference to a specific exemplary embodiment: Let us assume that the following sequence of coefficients is to be coded:

| | | | | | | | | | | |
|---|---|---|---|---|---|---|---|---|---|---|
| Index | 1 | 2 | 3 | 4 | 5 | 6 | 7 | 8 | . . . | 16 |
| Level | −1 | −2 | 1 | 0 | 0 | −2 | −1 | 0 | . . . | 0 |

The “insertion sorting” method is then carried out as shown in the following table:

| Step | | | | | | | | | | | |
|---|---|---|---|---|---|---|---|---|---|---|---|
| 1 | Index | 1 | | | | | | | | | |
| | Level | −1 | | | | | | | | | |
| 2 | Index | 2 | 1 | | | | | | | | |
| | Level | −2 | −1 | | | | | | | | |
| 3 | Index | 2 | 1 | 3 | | | | | | | |
| | Level | −2 | −1 | 1 | | | | | | | |
| 4 | Index | 2 | 1 | 3 | 4 | | | | | | |
| | Level | −2 | −1 | 1 | 0 | | | | | | |
| 5 | Index | 2 | 1 | 3 | 4 | 5 | | | | | |
| | Level | −2 | −1 | 1 | 0 | 0 | | | | | |
| 6 | Index | 2 | 6 | 1 | 3 | 4 | 5 | | | | |
| | Level | −2 | −2 | −1 | 1 | 0 | 0 | | | | |
| 7 | Index | 2 | 6 | 1 | 3 | 7 | 4 | 5 | | | |
| | Level | −2 | −2 | −1 | 1 | −1 | 0 | 0 | | | |
| 8 | Index | 2 | 6 | 1 | 3 | 7 | 4 | 5 | 8 | | |
| | Level | −2 | −2 | −1 | 1 | −1 | 0 | 0 | 0 | | |
| . . . | | | | | | | | | | | |
| 16 | Index | 2 | 6 | 1 | 3 | 7 | 4 | 5 | 8 | . . . | 16 |
| | Level | −2 | −2 | −1 | 1 | −1 | 0 | 0 | 0 | . . . | 0 |

The levels are now sorted in a descending sequence on the basis of their magnitude. There are five levels other than zero. Sorting information must now be formed for these five levels. This is done in the following five steps:

| Step | | 1 | 2 | 3 | 4 | 5 | 6 | 7 |
|---|---|---|---|---|---|---|---|---|
| 1 | Marker field in advance | | | | | | | |
| | Index | 2 | | | | | | |
| | Result | 1 | | | | | | |
| | Marker field subsequently | | X | | | | | |
| 2 | Marker field in advance | 1. | X | 2. | 3. | 4. | | |
| | Index | 6 | | | | | | |
| | Result | 4 | | | | | | |
| | Marker field subsequently | | X | | | | X | |
| 3 | Marker field in advance | | X | | | | X | |
| | Index | 1 | | | | | | |
| | Result | 0 | | | | | | |
| | Marker field subsequently | X | X | | | | X | |
| 4 | Marker field in advance | X | X | | | | X | |
| | Index | 3 | | | | | | |
| | Result | 0 | | | | | | |
| | Marker field subsequently | X | X | X | | | X | |
| 5 | Marker field in advance | X | X | X | | | X | |
| | Index | 7 | | | | | | |
| | Result | 2 | | | | | | |
| | Maker field subsequently | X | X | X | | | X | X |

The sequence of the results in the sorting information 19, which can be supplied to the entropy coder, and then reads as follows:

| | | | | |
|---|---|---|---|---|
| 1 | 4 | 0 | 0 | 2 |

The differential coding process which is carried out in the entropy coder 20 can be carried out in various ways. The various options will be explained in more detail in the following text with reference to the already described exemplary embodiment of the sorting method. Once the sorting method has been carried in the sorter 17, this results in the following sequence of level coefficients and sorting coefficients:

Level coefficients: 2 2 1 1 1

Sorting coefficients 1 4 0 0 2

These sequences of level coefficients and sorting coefficients can be differentially coded in various ways:

Exemplary Embodiment 1:

A first option is to form differences from successive level coefficients. The use of differences for coding the level coefficients results in the following number sequences:

1.1 Start at the first level coefficient: 2 0 1 0 0 EOB

1.2 Start of the last level coefficient: 1 0 0 1 0 EOB

Exemplary Embodiment 2:

The sorting information can also be differentially coded.

2.1 Direct coding: 1 4 0 0 2

2.2 Difference coding starting at the first sorting coefficient: 1 3 −4 0 2

2.3 Difference coding starting at the last sorting coefficient: 2 −2 0 4 −3

2.4 Difference coding using a predictor and starting at the first coefficient: 1 3 0 0 2

It should be noted that the predictor is in each case set to be equal to the last sorting coefficient, and that the predictor is in each case subtracted from the sorting coefficient to be coded at that time, in order to code that particular sorting coefficient. This procedure is continued for as long as the magnitudes of the associated level coefficients remain the same. If the values of the level coefficients change, the predictor is set to the start value of zero once again.

A program implementation of this coding process using a predictor is carried out as follows, as far as its part which is essential for this purpose is concerned:

| | | |
|---|---|---|
| PrevAbsLevel: = 0 | | |
| Pred: = 0 | {close oversize bracket} | *) |
| For i: = 0 to k − 1 do | | |

if not (abs(level[index[i]]) = PrevAbsLevel) then

Pred:0

| | | |
|---|---|---|
| Delta[i]: = result[i] − pred; | {close oversize bracket} | Picture Delta |
| Pred: = result[i] | | |
| PrevAbsLevel: = abs(level[index[i]]) | | |
| | {close oversize bracket} | Note current level and result |

End for
*) If the magnitude of the level has changed, the predictor must be reset to 0.

It should be noted that, in the exemplary embodiments 1 and 2, the EOB symbol need be coded only once, that is to say either in conjunction with the level coefficients or in conjunction with the sorting coefficients.

Exemplary Embodiment 3:

It is also possible to combine a number of level values. The coding process is then carried out in number pairs, with the first number indicating the difference from the preceding level coefficient. In contrast, a second number indicates how often the level coefficient occurs. There is no need for an EOB symbol when using number pairs for coding:

3.1 Start at the first level coefficient: (2, 2) (1, 3)

3.2 Start at the last level coefficient: (1, 3) (1, 2)

Exemplary Embodiment 4:

A number of sorting coefficients may also be combined since, quite frequently, the sorting coefficients have the value zero a number of times successively. These zero sequences can be effectively compressed using zero running length coding. The coding is then carried out in number pairs, with a first number indicating that sorting coefficient which is not zero, and a second number indicating the number of zeros located before the sorting coefficient which is not zero.

4.1 Direct coding of the sorting coefficients without differences: (1, 0) 4, 0) (2, 2)

4.2 Combination of the sorting coefficients that have been differentially coded in accordance with 2.2: (1, 0) (3, 0) (−4, 0) (2, 1)

4.3 Combination of the sorting coefficients which have been differentially coded in accordance with 2.3: (2, 0) (−2, 2) (4, 1) (−3, 0)

4.4 Combination of sorting coefficients which have been differentially coded in accordance with 2.4: (1, 0) (3, 0) (2, 2)

The information that no re-sorting whatsoever can be carried out may be coded by a separate symbol since, in this case, all the sorting coefficients are equal to zero.

Exemplary Embodiment 5:

It is also possible to combine each of the level coefficients and sorting coefficients in pairs. The coding process is then carried out in number pairs, with a first number indicating the difference from the preceding level coefficient, and the second number indicating the associated sorting coefficient.

5.1 Start at the first coefficient: (2, 1) (0, 4) (1, 0) (0, 0) (0, 2) EOB

5.2 Start at the last coefficient: (1, 2) (0, 0) (0, 0) (1, 4) (0,1) EOB

Exemplary Embodiment 6:

If EOB information is required to separate the transmitted number, this can in each case be linked to the transmitted numbers. In the case of exemplary embodiments 1 and 2, this then results in tuples, while exemplary embodiments 3 to 5 result in triples.

The number sequences generated in accordance with exemplary embodiments 1 to 5 can then be coded by VLC (Variable Length Code) coding. This may be done, in particular, by the known VLC coding using Huffmann codes. The Huffmann codes are generated using a known method, on the basis of the probability of occurrence of the symbols to be coded. The Huffmann codes are known to those skilled in the art and, as such, are not the subject matter of the application.

In addition to the levels, the mathematical signs must also be coded. Since there is no correlation in the mathematical signs, the mathematical signs may be coded using one bit for each coefficient which is not zero. For example, a negative mathematical sign of a level coefficient may be coded by a logic one, and a positive mathematical sign may be coded by a logic zero.

Instead of the Huffmann code, it is also possible to use the UVLC (Universal Variable Length Code), which is already used in the H.26L test model. In the context of UVLC, the symbols are likewise associated with the codes on the basis of a previously determined probability of occurrence, or on the basis of a so-called “Move to Front” algorithm. A further option is to use code which can be generated analytically, for example the Golomb code.

In principle, decoding is carried out in the inverse manner to encoding, and its description therefore follows indirectly from the description of the encoding process. However, to assist understanding, the following text also describes the decoding process according to the invention on the basis of the above specific exemplary embodiment:

First of all, any differential coding or delta coding must be reversed. This is done by decoding a symbol, addition of a delta value or addition of the predictor and adaptation of the predictor, in an analogous manner to the encoding process. After this step, the following data is available at the decoder end:

Firstly, the decoded, sorted levels:

| | | | | |
|---|---|---|---|---|
| −2 | −2 | −1 | 1 | −1 |

Secondly, the decoded sorting and positioning information:

| | | | | |
|---|---|---|---|---|
| 1 | 4 | 0 | 0 | 2 |

The marker field, as used for encoding, is required once again for decoding the position information. At the start of the process of decoding a block, this is in an unmarked form. If the position information is equal to k, then k unmarked positions are jumped over in the marker field, in each case from the start of the marker field, and the unmarked position after this is the desired index. This point in the marker field is then marked, and the index for this point is the index for the associated level. This means that the level must be located at this point in the reconstructed block.

The processing of the position information will be described on the basis of the position information 1, 4, 0, 0, 2:

| Step | | 1 | 2 | 3 | 4 | 5 | 6 | 7 |
|---|---|---|---|---|---|---|---|---|
| 1 | Marker field in advance | | | | | | | |
| | Position information | 1 | | | | | | |
| | Resultant index | 2 | | | | | | |
| | Marker field subsequently | | | | | | | |
| 2 | Marker field in advance | 1. | X | 2. | 3. | 4. | | |
| | Position information | 4 | | | | | | |
| | Resultant index | 6 | | | | | | |
| | Marker field subsequently | | X | | | | X | |
| 3 | Marker field in advance | | X | | | | X | |
| | Position information | 0 | | | | | | |
| | Resultant index | 1 | | | | | | |
| | Marker field subsequently | X | X | | | | X | |
| 4 | Marker field in advance | X | X | | | | X | |
| | Position information | 0 | | | | | | |
| | Resultant index | 3 | | | | | | |
| | Marker field in advance | X | X | X | | | X | |
| 5 | Marker field in advance | X | X | X | | | X | |
| | Position information | 2 | | | | | | |
| | Resultant index | 7 | | | | | | |
| | Marker field | X | X | X | | | X | X |

The resultant indices for the sorted levels are thus:

| | | | | |
|---|---|---|---|---|
| −2 | −2 | −1 | 1 | −1 |
| 2 | 6 | 1 | 3 | 7 |

Finally, the decoded block once again becomes:

| | | | | | | | | | | |
|---|---|---|---|---|---|---|---|---|---|---|
| Index | 1 | 2 | 3 | 4 | 5 | 6 | 7 | 8 | . . . | 16 |
| Level | −1 | −2 | 1 | 0 | 0 | −2 | −1 | 0 | . . . | 0 |

The methods described here for differential coding and decoding are suitable for use in conjunction with existing video standards such as H.263 and MPEG-4. The methods may also be used for standards such as H.26L, which are currently being standardized, as well as the corresponding future standards.

Finally, it should be noted that the apparatuses and methods described here may be not only in hardware form but also in software form.

The invention has been described in detail with particular reference to preferred embodiments thereof and examples, but it will be understood that variations and modifications can be effected within the spirit and scope of the invention.

What is claimed is:

1. A method for coding video signals, comprising:
providing a prediction error matrix;
converting the prediction error matrix to a sequence of level coefficients and length coefficients of zero sequences;
sorting the level coefficients based on magnitude and forming a sequence of sorting coefficients; and
differential coding of the level coefficients.

2. The method as claimed in claim 1, further comprising coding differences between successive level coefficients.

3. The method as claimed in claim 2, further comprising combining the level coefficients into number pairs, with a first number in each number pair indicating a difference value of level change, and a second number in each number pair indicating a number of repetitions of the level change.

4. The method as claimed in claim 3, further comprising differentially coding the sorting coefficients.

5. The method as claimed in claim 4, wherein said differentially coding of the sorting coefficients includes coding differences between successive sorting coefficients.

6. The method as claimed in claim 4, wherein said differentially coding of the sorting coefficients includes coding differences with respect to a predictor for each of the sorting coefficients.

7. The method as claimed in claim 6, further comprising combining the differences between successive level coefficients in pairs using sorting coefficients.

8. The method as claimed in claim 2, further comprising coding the sorting coefficients in number pairs, with a first number indicating the value of a sorting coefficient which is not zero, and a second number indicating the length of an adjacent zero sequence.

9. The method as claimed in claim 2, further comprising combining the differences between successive level coefficients in pairs using sorting coefficients.

10. The method as claimed in claim 9, wherein said coding of the differences starts with a first coefficient.

11. The method as claimed in claim 9, wherein said coding of the differences starts with a last coefficient.

12. The method as claimed in claim 11, wherein at least one of the sequence of sorting coefficients or a sequence of differences between sorting coefficients is identified by a symbol terminating the sequence.

13. A method for decoding video signals, comprising:
differential decoding of level coefficients;
decoding sorting information and re-sorting of the level coefficients based on the sorting information; and
converting a sequence of the level coefficients and length coefficients of zero sequences to a prediction error matrix.

14. At least one computer readable medium storing at least one program for controlling a processor to perform a method comprising:
providing a prediction error matrix;
converting the prediction error matrix to a sequence of level coefficients and length coefficients of zero sequences;
sorting the level coefficients based on magnitude and forming a sequence of sorting coefficients; and
differential coding of the level coefficients.
